(19) United States
(12) Patent Application Publication
(10) Pub. No.: US 2021/0276492 A1
(43) Pub. Date: Sep. 9, 2021

(54) ADD-ON SYSTEM ARRANGEMENT FOR A VEHICLE

(71) Applicant: Rheinmetall Landsysteme GmbH, Unterluess (DE)

(72) Inventor: Andreas BAUMEIER, Unterluess (DE)

(73) Assignee: Rheinmetall Landsysteme GmbH, Unterluess (DE)

(21) Appl. No.: 17/115,127

(22) Filed: Dec. 8, 2020

Related U.S. Application Data
(63) Continuation of application No. PCT/EP2019/063623, filed on May 27, 2019.

(30) Foreign Application Priority Data
Jun. 8, 2018 (DE) 20 2018 103 226.7

(51) Int. Cl. B60R 9/00; B60R 11/00

(52) U.S. Cl. CPC B60R 9/00; B60R 11/00; F41A 23/20; B60R 2011/0085; B60R 2011/0082

(57) ABSTRACT

A vehicle having a chassis and at least one add-on system. The add-on system is arranged on the vehicle. Furthermore, at least one movable wall and/or panel is arranged on the vehicle. In this case the add-on system as well as the movable wall and/or panel can assume an operating position and a rest position, wherein in the rest position the add-on system is completely concealed by the movable wall and/or panel. In the rest position the movable wall and/or panel is inserted into the contour of the vehicle in such a way that a continuously closed contour is present on the vehicle.

This nonprovisional application is a continuation of International Application No. PCT/EP2019/063623, which was filed on May 27, 2019, and which claims priority to German Patent Application No. 20 2018 103 226.7, which was filed in Germany on Jun. 8, 2018, and which are both herein incorporated by reference.

### BACKGROUND OF THE INVENTION

### Field of the Invention

The present invention relates to a vehicle having at least one add-on system, which is arranged on or at the vehicle.

### Description of the Background Art

Add-on systems within the context according to the invention are additions at the vehicle in order to provide the vehicle with further functions. They include, for example, optical systems, such as cameras, objective and light-generating systems, acoustic systems, such as antenna systems, listening devices or loudspeakers, but also weapon systems, such as missile systems, laser weapons, secondary weapon systems, soft kill applications and non-lethal weapon systems. Furthermore, electromagnetic systems, such as detectors, can be considered to be an add-on system within the context of the present invention.

Vehicles, in particular security vehicles and also military and combat vehicles, are equipped, as is known, with various add-on systems as mentioned previously. The add-on systems are arranged at the vehicle and are visible.

Due to the fact that, in the case of conventional vehicles, the add-on systems are arranged on the outside of the vehicle, this has the disadvantage of signature deterioration of the vehicles and susceptibility to damage when passing through rough terrain or pieces of woodland. Furthermore, inspecting the vehicle in poor light conditions is associated with an increased risk of injury and/or tripping.

In order to improve the signature of a vehicle, it is known, for example, from WO 2013/050834 A1, which corresponds to US 2014/0150637, to cover main weapons with movable doors such that the main weapons are no longer visible. For this purpose, a second housing is placed through the aforementioned doors over the weapon such that the latter is no longer visible. The doors make it possible, by means of the additional casing, to conceal the type of weapon, but not the fact that a weapon is present.

A cannon for a ship is likewise known from DE 277 306 A, in which a cover can cover a cannon in an armoured shaft. Here too, however, the armoured shaft of the cannon continues to be visible.

### SUMMARY OF THE INVENTION

It is therefore an object of the present invention to be able to conceal the aforementioned add-on systems at or in the vehicle in such a manner that they cannot be seen from the outside and cause as little signature deterioration as possible of the vehicle itself.

The present invention proposes a vehicle having a chassis, having at least one add-on system, which is arranged on or at the vehicle. The vehicle in this case can be a land vehicle, a watercraft or an aircraft, and it can be a light or heavy vehicle with or without armouring.

Furthermore, the vehicle according to the invention comprises at least one movable wall and/or flap, wherein the additional system and the movable wall and/or flap can take up a use position and a concealed position. The movement from one position into the other can take place manually or in an automated manner. For this purpose, for example, the add-on system can be arranged on a rail. The add-on system can be moved on the latter from the concealed position into the use position or vice versa. However, hydraulic or electric movements out of the two positions are also conceivable.

In the concealed position, the add-on system is completely concealed by the movable wall and/or the flap. According to the invention, in the concealed position, the movable wall and/or the flap merely has the external shape of the vehicle at the location at which the movable wall and/or the flap is arranged. This arrangement of the movable wall and/or of the flap does not change the contour of the vehicle, and therefore, in the concealed position, the vehicle has a continuously closed contour. The continuously closed contour means that the add-on systems cannot be seen from the outside and cause a very low, if any, signature deterioration of the vehicle.

According to the invention, the present vehicle can be equipped with only one add-on system, which is configured as mentioned previously. A plurality of add-on systems of differing type may also be provided. In addition to the aforementioned add-on systems, drones are also conceivable which can take up a use position outside the vehicle.

For the concealed position of the add-on systems, the vehicle is preferably provided with at least one cavity in which the add-on system is in its concealed position. The cavity is then closed in the concealed position by the movable wall and/or the flap.

The wall and/or flap, like the entire vehicle, can also be provided with protective elements. The movable wall and/or the flap can thus be, for example, armoured or can have certain light filters.

In an example, the cavity which is responsible for accommodating the add-on systems in the concealed position is configured to be larger than the space which the add-on system takes up. This non-appropriated cavity can then be available to the vehicle as a storage space.

The vehicle can have a turret which is mounted rotatably in relation to the chassis. The corresponding add-on systems can then be attached together with the movable wall and/or the flap to the chassis or to the turret. A combination of both is also possible.

The add-on systems are particularly preferably fastened releasably, which affords the advantage that the add-on devices may be interchanged in the concealed position. This can take place from the interior of the vehicle if the vehicle has corresponding access to the cavity in which the add-on system is located. For the interchanging, further add-on systems can be carried along in the vehicle or the add-on systems are interchanged from two different cavities. The vehicle can thereby be adapted individually to certain operational areas.

Military and/or armoured vehicles frequently have a hatch. In a further particular embodiment, this hatch can serve as a flap and can likewise already conceal an add-on system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective illustration of a vehicle with an add-on system in the concealed position.

FIG. 2 shows a perspective illustration of a vehicle with an add-on system in the use position.

FIG. 3 shows a perspective illustration of a vehicle with a drone as an add-on system.

### DETAILED DESCRIPTION

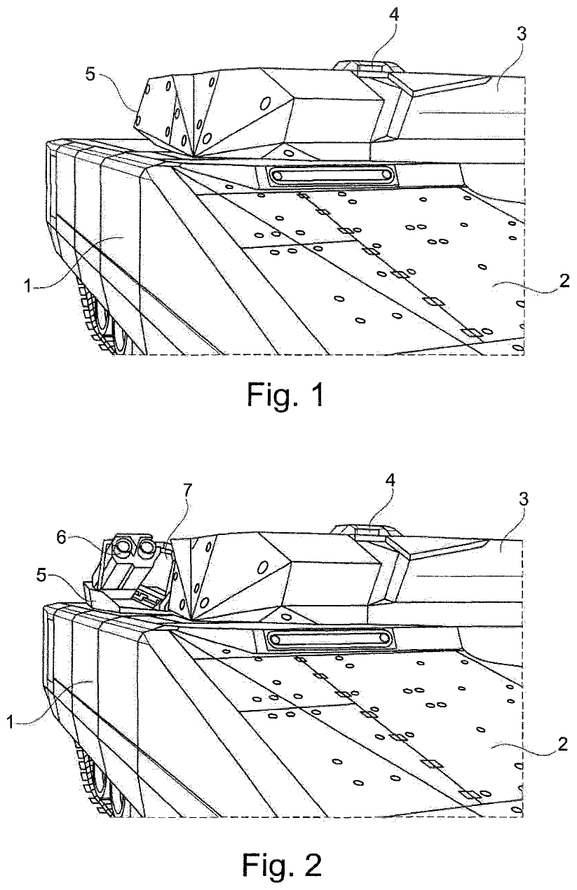

FIG. 1 shows a perspective illustration of a vehicle according to the invention having a chassis 1 and an add-on system which is not visible and is arranged on the vehicle. The add-on system is not visible since it is covered by a flap 5 at the vehicle.

The present vehicle additionally to the chassis 1 includes a turret 3, which is mounted on the vehicle so as to be rotatable in relation to the chassis 1.

The flap 5 is attached movable to the turret 3 and is shown at this instant in the concealed position. However, the flap 5 can be moved out of the concealed position into a use position by moving and releasing the cavity which is located therebehind and has the add-on system.

The movement of the flap 5 is a rotational movement. The flap has a rotatable coupling by means of which the flap 5 can be tilted. However, other movements of the flap 5, such as for example a displacement or folding, are also possible. The same is true of a movable wall.

The vehicle in FIG. 1 is designed as an armoured vehicle and has a hatch 4. The hatch 4 can also serve as a flap 5 and can conceal an add-on system located therebelow.

The flap 5 is configured in such a manner that it does not change the contour of the turret 3 or of the entire vehicle in the concealed position. In the concealed position, the vehicle thus has a continuously closed contour, and, as a result, the signature of the vehicle is not changed and it is not possible to see from the outside which add-on system is being carried along on the vehicle. Accordingly, it is more difficult for an attacker or for an external action to adapt to the add-on systems of the vehicle.

Instead of a flap 5, a movable wall 2 can also be used to conceal an add-on system. For example, a further weapon could be concealed under the wall 2 in FIG. 1. The wall 2 and the add-on system located therebelow can then be moved out of the concealed position shown into a use position.

FIG. 2 shows the perspective illustration of the vehicle from FIG. 1, but with the add-on systems 6 and the flap 5 in the use position.

A weapon system which is arranged at the flap 5 is shown as the add-on system 6. Flap 5 tilts downward away from its concealed position and thereby releases the add-on system, which is arranged at the flap 5, and the cavity 7, in which the add-on system 6 was arranged for this purpose in the concealed position and which was previously concealed by the flap 5.

In its use position, the add-on system 6 is fully functional and also visible, in contrast to the concealed position which it has previously taken up.

The weapon system which is concealed by the wall 2 is still shown in FIG. 2 in the concealed position. It is thus possible to allow different add-on systems 6 to be brought into different positions. Some add-on systems 6 can thus be in the use position while others are still in the concealed position.

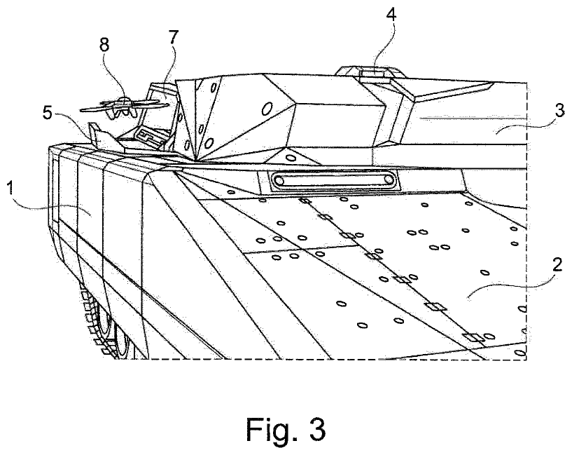

FIG. 3 shows a similar vehicle as in the previous drawings, but a drone 8 is now shown as the add-on system. In contrast to the previous figure, the drone 8 is not fastened at a flap 5 but rather is located in the concealed position in the cavity 7. It can be fastened for this purpose, for example, by means of latching. In the use position, i.e. with the flap 5 tilted downward, the cavity 7 is opened outward and the drone 8 can move into its use position. This can be outside the vehicle.

FIG. 3 shows the cavity 7 which is configured to be larger than the space taken up by the drone 8. The space which is not appropriated in the cavity 7 can therefore be used in both positions as a storage space.

The vehicles in the aforementioned figures are each equipped with protective elements, in this case armouring. Corresponding protective elements can also be provided for the flap 5 or the walls 2 in order to maintain the level of protection of the vehicle.

In all of the figures, the cavity 7 is accessible from within the vehicle, and therefore the add-on systems 6 can be maintained and/or can be interchanged for other add-on systems from the interior of the vehicle. For the interchanging of the add-on systems, the latter have to be fastened releasably. A releasable fastening can be brought about, for example, by screwing or latching or clamping connections.

The present invention is not restricted to the aforementioned features. On the contrary, further refinements are conceivable. The add-on systems could thus be arranged at a ship or aircraft. Furthermore, it is conceivable to use the storage space in the cavities as an ammunition depot.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A vehicle comprising:
a chassis;
at least one add-on system arranged on or at the vehicle;
at least one movable wall and/or flap arranged at the vehicle;
wherein the add-on system and the movable wall and/or flap takes up a use position and a concealed position,
wherein the add-on system in its concealed position is completely covered by the movable wall and/or flap, and
wherein, in the concealed position, the vehicle has a continuously closed contour via the movable wall and/or the flap.

2. The vehicle according to claim 1, wherein the add-on system comprises a weapon system.

3. The vehicle according to claim 1, wherein the add-on system comprises a drone.

4. The vehicle according to claim 1, wherein the add-on system comprises a detector.

5. The vehicle according to claim 1, wherein the add-on system comprises a defence system.

6. The vehicle according to claim 1, wherein various add-on systems are arranged on the vehicle.

7. The vehicle according to claim 1, wherein the add-on system is arranged releasably at the movable wall and/or flap.

8. The vehicle according to claim 1, wherein the add-on system in its concealed position is arranged in at least one cavity which is located within the vehicle or in the vehicle contour.

9. The vehicle according to claim 1, wherein the add-on system is configured to be movable between the use position and the concealed position.

10. The vehicle according to claim 1, wherein the wall and/or flap have protective elements.

11. The vehicle according to claim 8, wherein another cavity not appropriated by an add-on system is available as a storage space.

12. The vehicle according to claim 1, wherein the vehicle has a turret which is mounted rotatably in relation to the chassis.

13. The vehicle according to claim 1, wherein the add-on system is arranged on or at the chassis.

14. The vehicle according to claim 12, wherein the add-on system is arranged on or at the turret.

15. The vehicle according to claim 1, wherein the add-on system is configured to be interchangeable in its concealed position.

16. The vehicle according to claim 1, wherein a hatch, which serves as a flap, is provided at the vehicle.
